(19) United States
(12) Patent Application Publication
(10) Pub. No.: US 2025/0380670 A1
(43) Pub. Date: Dec. 18, 2025

(54) Adjustable Smart Pet Collar with Enhanced Camera Positioning and Real-Time Monitoring Capabilities

(71) Applicant: David Saul, Edmonton (CA)

(72) Inventor: David Saul, Edmonton (CA)

(21) Appl. No.: 18/746,095

(22) Filed: Jun. 18, 2024

(51) Int. Cl. A01K 27/00; A01K 11/00; A01K 29/00

(52) U.S. Cl. CPC A01K 27/001; A01K 11/008; A01K 27/009; A01K 29/005

(57) ABSTRACT

A smart pet collar device comprising a housing containing a camera module, GPS module, wireless communication module, and a power source. The device includes an adjustable mounting mechanism with a linear track and rotating wheel, allowing the camera module to be positioned at an adjustable offset relative to a collar. The housing is secured to the collar through an attachment mechanism that permits repositioning. A control module within the housing interfaces with the camera module, GPS module, and wireless communication module, and is configured to connect with a remote device. The device facilitates real-time video streaming and GPS tracking for pets.

### FIELD OF INVENTION

The present invention relates generally to smart pet collars equipped with GPS tracking and video streaming capabilities. Specifically, it concerns an adjustable pet collar that optimizes camera positioning to provide unobstructed views and enhanced monitoring of pets.

### BACKGROUND

In the realm of pet monitoring systems, existing technologies provide various functionalities aimed at enhancing the safety and well-being of pets. Smart collars with integrated GPS and video capabilities are prevalent, enabling pet owners to track their pets' locations and view their surroundings in real-time. These devices typically communicate with a user's mobile device via wireless protocols such as 4G or WiFi, offering a degree of control and monitoring convenience.

However, despite these advancements, several limitations persist in current systems. One significant drawback is the obstruction caused by the pet's head, which frequently interferes with the camera's field of view. This obstruction leads to poor-quality video streams and limits the effectiveness of visual monitoring, especially in the case of smaller pets or those with specific physical attributes, such as long hair or unique head shapes.

Another common issue is the rigidity of the camera positioning mechanisms. Many existing devices lack the flexibility to adjust the camera's orientation and position adequately, which is necessary to cater to pets of varying sizes and shapes. This lack of adjustability results in suboptimal viewing angles and further diminishes the utility of the video feature.

Additionally, the attachment mechanisms employed by current smart collars often do not provide sufficient stability and security, particularly during vigorous pet activities. This instability can cause the camera to shift, leading to inconsistent video quality and potential damage to the device. Moreover, many existing systems are not designed to withstand harsh environmental conditions, which are frequently encountered by pets, thereby compromising the device's durability and longevity.

The integration of multiple functionalities, such as GPS tracking and video streaming, in existing smart collars also often results in significant power consumption. This leads to frequent battery depletion, necessitating regular recharging and reducing the overall convenience for pet owners. Furthermore, the user interfaces of the associated mobile applications are sometimes cumbersome and not user-friendly, hindering the seamless operation and full utilization of the device's features.

These limitations highlight the need for a more sophisticated and robust solution that not only addresses the visual obstruction issue but also enhances the adjustability, stability, and durability of the device, while ensuring efficient power management and an intuitive user interface. Such improvements would significantly elevate the utility and reliability of smart pet collars, providing pet owners with a more effective tool for monitoring and interacting with their pets.

It is within this context that the present invention is provided.

### SUMMARY

The present invention relates to a smart pet collar device designed to provide real-time video streaming and GPS tracking. The device includes a housing containing a camera module, a GPS module, a wireless communication module, and a power source. An adjustable mounting mechanism allows the camera module to be positioned at an optimal offset relative to the collar, and an attachment mechanism secures the housing to the collar. The control module within the housing interfaces with a remote device to manage these functionalities.

In some embodiments, the camera module includes an adjustable lens to change the field of view, allowing for better visual coverage of the pet's surroundings.

In some embodiments, the housing is waterproof, ensuring protection of the internal electronic components from water and harsh environmental conditions.

In some embodiments, the wireless communication module supports both 4G and WiFi connectivity, providing versatile communication options for interfacing with remote devices.

In some embodiments, the device includes a speaker operatively connected to the control module, enabling the transmission of audio signals and voice commands from a remote device.

In some embodiments, a microphone is included within the housing, allowing for audio data transmission to the remote device, thereby facilitating two-way audio communication.

In some embodiments, the control module interfaces with a mobile application on a remote device via a software API, allowing users to control and monitor the device's functions conveniently.

In some embodiments, an accelerometer is integrated within the housing to provide motion data for monitoring the pet's activity levels, enhancing the device's ability to track and analyze the pet's movements.

In some embodiments, the attachment mechanism comprises a zip-tie type attachment with a locking mechanism, ensuring secure and stable attachment to the pet's collar.

In some embodiments, a rechargeable battery is used as the power source, and the housing includes a charging port connected through a power management circuit, enabling easy recharging and efficient power use.

In some embodiments, the control module includes onboard memory for storing and transmitting location and video data, ensuring data integrity and availability even in the absence of real-time connectivity.

In some embodiments, a light source, such as an LED, is integrated into the housing, operatively connected to the control module, allowing the emission of light signals based on remote commands.

In some embodiments, the control module tracks and records the pet's location history for up to 30 days, using onboard memory and a retrieval algorithm to provide comprehensive location data over time.

In some embodiments, the control module analyzes the pet's activity data to provide insights into the pet's rest and sleep patterns, using data from the accelerometer to identify sleep states and activity levels.

In some embodiments, the control module sends alerts to the remote device when the pet leaves a predefined geographic area, utilizing a geofencing algorithm to enhance pet safety.

In some embodiments, the control module generates and displays a trace of the pet's route on a map within the mobile application, providing a visual representation of the pet's movements over time.

In some embodiments, the control module adjusts the frequency of GPS data transmission to conserve battery power when the device is not actively monitored, employing a power management algorithm to optimize battery life.

### BRIEF DESCRIPTION OF THE DRAWINGS

Various embodiments of the invention are disclosed in the following detailed description and accompanying drawings.

FIG. 1A illustrates an example perspective view of the smart pet collar device.

FIG. 1B illustrates an example rear view of the smart pet collar device.

FIG. 1C illustrates an example top-down view of the smart pet collar device, showing the camera lens.

FIG. 1D illustrates an example side view of the smart pet collar device, showing the on/off button.

FIG. 2 illustrates an example block diagram of the internal electrical components within the housing of the smart pet collar device.

FIG. 3 illustrates an example of the smart pet collar device being worn by a pet, with the camera's field of view unobstructed, and in wireless communication with a user device displaying a live stream from the camera.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

The use of spatial terms, such as “under,” “below,” “lower,” “over,” “upper,” etc., is used for ease of explanation to describe the relationship between elements when the apparatus is in its proper orientation.

As used herein, the term “housing” refers to any structure or enclosure designed to contain and protect the internal components of the smart pet collar device. The housing can be made from various materials, including but not limited to plastic, metal, or composite materials, and may feature properties such as waterproofing or impact resistance to safeguard the internal electronics.

The term “camera module” encompasses any device capable of capturing still images or video. This includes, but is not limited to, digital cameras, webcams, and other image capturing devices. The camera module may include an image sensor, lens, and associated electronics for processing and transmitting visual data.

The term “GPS module” refers to any device capable of determining geographic location using signals from the Global Positioning System. The GPS module may also be capable of interfacing with other satellite-based navigation systems such as GLONASS, Galileo, or BeiDou.

The term “wireless communication module” refers to any hardware component that enables wireless data transmission. This includes, but is not limited to, modules supporting 4G LTE, WiFi, Bluetooth, or other wireless communication protocols. The wireless communication module facilitates connectivity between the smart pet collar device and external devices such as smartphones, tablets, or computers.

The term “power source” encompasses any component or system that provides electrical power to the device. This includes, but is not limited to, rechargeable batteries, disposable batteries, solar cells, or other energy harvesting technologies. The power source is responsible for supplying the necessary electrical energy to the camera module, GPS module, wireless communication module, and control module.

The term “adjustable mounting mechanism” refers to any system or assembly that allows the position and orientation of the camera module to be adjusted relative to the collar. This includes, but is not limited to, linear tracks, rotating wheels, pivoting joints, or other mechanical systems that provide adjustable positioning capabilities.

The term “attachment mechanism” refers to any means of securing the housing to a pet collar. This includes, but is not limited to, zip-tie type attachments, clips, straps, buckles, or other fastening systems that ensure the housing remains securely attached to the collar during use.

The term “control module” encompasses any electronic system or microcontroller that manages the operation of the smart pet collar device. The control module is responsible for processing data from the camera module, GPS module, and wireless communication module, as well as interfacing with external devices and executing software algorithms for various functionalities.

Example implementations of the “power source” include a lithium-ion rechargeable battery with a capacity of 1000 mAh, a set of AA alkaline batteries, or a solar panel array capable of generating sufficient power under normal daylight conditions. Example “wireless communication protocols” include IEEE 802.11 (WiFi), 4G LTE standards, and Bluetooth 5.0. Example external devices that the smart pet collar device might communicate with include Android and iOS smartphones running a dedicated mobile application, tablets, and desktop computers equipped with compatible wireless communication hardware.

### Description of Drawings

The present invention relates to a smart pet collar device designed to enhance pet monitoring and tracking capabilities through advanced technological integration. This invention addresses several shortcomings observed in the prior art, including visual obstruction caused by the pet's head, limited adjustability of camera positioning, inadequate attachment stability, and high power consumption.

In general terms, the smart pet collar device comprises a housing containing a camera module, GPS module, wireless communication module, and a power source. An adjustable mounting mechanism allows the camera module to be positioned at an optimal offset relative to the collar, thereby avoiding obstruction by the pet's head and improving the field of view. The housing is designed to be waterproof, protecting the internal components from environmental damage.

One of the primary benefits of this invention is the enhanced camera positioning capability. The adjustable mounting mechanism, featuring a linear track and rotating wheel, allows the camera to be repositioned easily to suit different pet sizes and shapes. This ensures that the camera can capture clear and unobstructed video footage from the pet's perspective, addressing a significant drawback in existing devices.

The invention also includes a robust attachment mechanism that secures the housing to the pet's collar, ensuring stability even during vigorous activities. This attachment system reduces the likelihood of the camera shifting out of position, thereby maintaining consistent video quality.

Power management is another area where this invention excels. The smart pet collar device utilizes a rechargeable battery with efficient power consumption strategies, such as dynamic GPS data transmission intervals, to extend battery life. This reduces the need for frequent recharging and enhances the overall convenience for pet owners.

Additionally, the device is equipped with a speaker and microphone for two-way audio communication, an accelerometer for activity monitoring, and an integrated light source for signaling purposes. These features, combined with the ability to interface with a mobile application, provide pet owners with comprehensive tools for tracking, monitoring, and interacting with their pets.

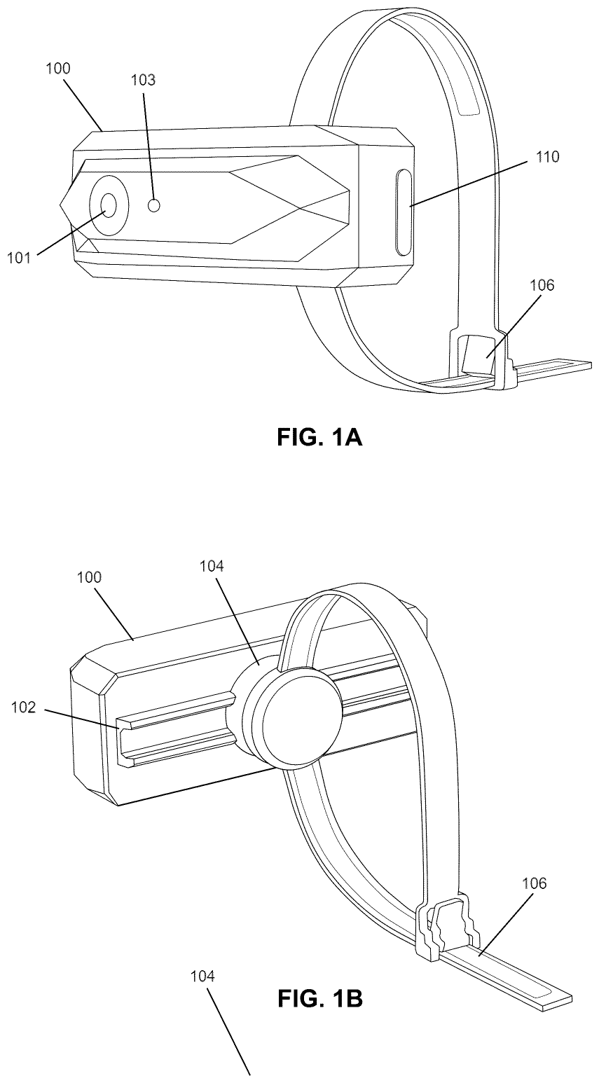

Referring now to the drawings, FIGS. 1A-1D show various views of an example configuration of the smart collar attachment of the present disclosure.

FIG. 1A shows a perspective view of the smart pet collar device. The device comprises a housing 100, which contains the camera module with a lens 101 on the front surface, GPS module, wireless communication module, and power source. An LED indicator 103 is also disposed on the front surface to show whether the device is currently active.

The housing 100 is designed to be waterproof and robust, protecting the internal components from environmental damage. Attached to the housing 100 is an adjustable mounting mechanism, including a linear track 102 and a rotating wheel 104. This mechanism allows the camera module to be positioned at an adjustable offset relative to the collar. The attachment mechanism includes a zip-tie ratchet style attachment 106, which securely couples the housing 100 to a pet collar.

In FIG. 1B, the rear view of the smart pet collar device is illustrated. This view highlights the linear track 102 and the rotating wheel 104 more clearly, showing how the wheel 104 is coupled to the track 102. The rotating wheel 104 allows the housing 100 to rotate about an axis, enabling the camera module to adjust its position for optimal viewing angles. The zip-tie ratchet style attachment 106 is shown in its secured state, ensuring the housing 100 remains stable during use.

FIG. 1C presents a top-down view of the smart pet collar device. The camera lens 108 is visible on the front surface of the housing 100, positioned to capture video from the pet's perspective. The linear track 102 and rotating wheel 104 mechanism is shown in greater detail, illustrating how the housing 100 can move along the track 102 to adjust the camera's position. The attachment mechanism 106 is shown wrapping around a collar, highlighting the secure fit provided by the ratchet style attachment.

In FIG. 1D, the side view of the smart pet collar device is depicted. The on/off button 110 is visible on the top surface of the housing 100, allowing easy access for the user to power the device on and off. The linear track 102 and rotating wheel 104 are shown from above, further illustrating the range of motion and adjustability provided by the mounting mechanism. The zip-tie ratchet style attachment 106 is displayed securing the housing 100 to the collar, demonstrating the device's stability and versatility in different configurations.

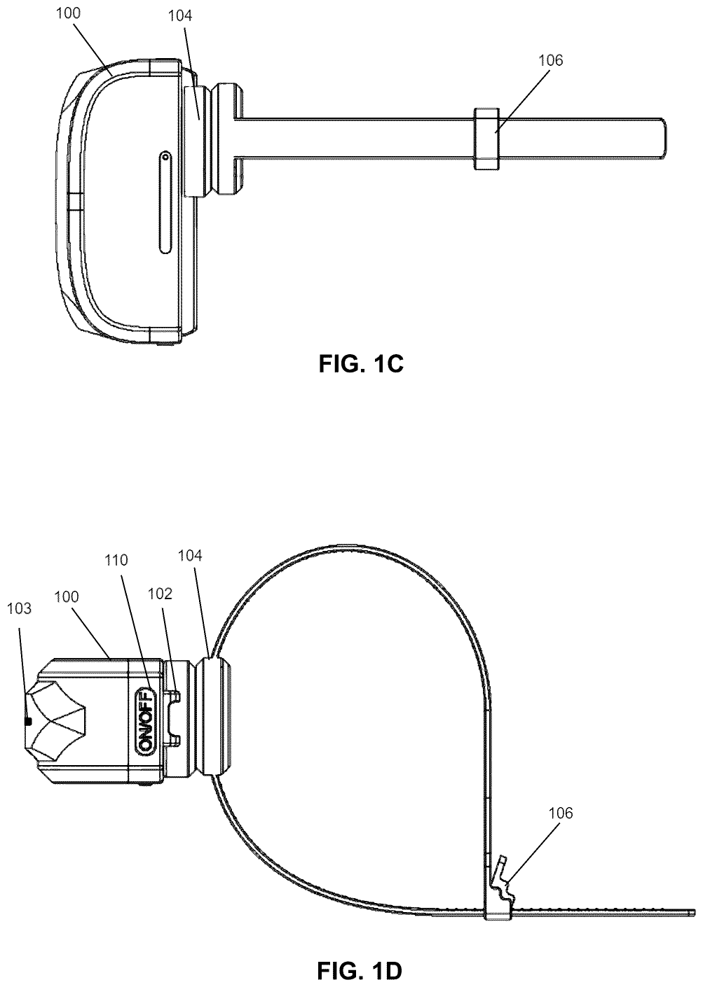

FIG. 2 illustrates a block diagram of the internal electrical components within the housing 100 of the smart pet collar device. The device comprises several interconnected modules and components that enable its various functionalities.

The central component is the control module 200, which orchestrates the operations of the entire device. The control module 200 is connected to the power source 202, which supplies the necessary electrical energy to all the internal components. The power source 202 is preferably a rechargeable battery, which is managed by a power management circuit 204 to ensure efficient power usage and recharging capabilities through a charging port 206.

The camera module 208 is connected to the control module 200 and includes an image sensor and adjustable lens. The control module 200 processes the video data captured by the camera module 208 and transmits it via the wireless communication module 210. The wireless communication module 210 supports 4G LTE and WiFi connectivity, facilitated by an antenna 212, to interface with external devices such as smartphones and tablets.

The GPS module 214 is also connected to the control module 200, enabling real-time location tracking of the pet. The GPS module 214 receives satellite signals and transmits location data to the control module 200, which can then relay this information to a remote device via the wireless communication module 210.

An accelerometer 216 is included within the housing 100, connected to the control module 200 to provide motion data for activity monitoring. The accelerometer 216 allows the control module 200 to analyze the pet's movements and track activity levels, including rest and sleep patterns.

A speaker 218 is integrated into the housing 100 and connected to the control module 200, enabling the emission of audio signals and voice commands from a remote device. Additionally, a microphone 220 is connected to the control module 200, allowing for two-way audio communication by transmitting audio data from the pet's environment back to the remote device.

The smart pet collar device also includes a light source 222, such as an LED, which is connected to the control module 200. The light source 222 can be activated in response to signals from the remote device, providing visual signals or aiding in locating the pet.

The control module 200 features onboard memory for storing location and video data, ensuring data integrity even when real-time transmission is not possible. The memory allows for temporary storage of data, which can later be transmitted to the remote device when connectivity is restored.

The control module 200 is also equipped with a software API that interfaces with a mobile application on a remote device. This mobile application allows users to control and monitor the smart pet collar device, accessing video streams, location data, and activity reports. The software API facilitates communication between the control module 200 and the mobile application, ensuring seamless operation and user interaction.

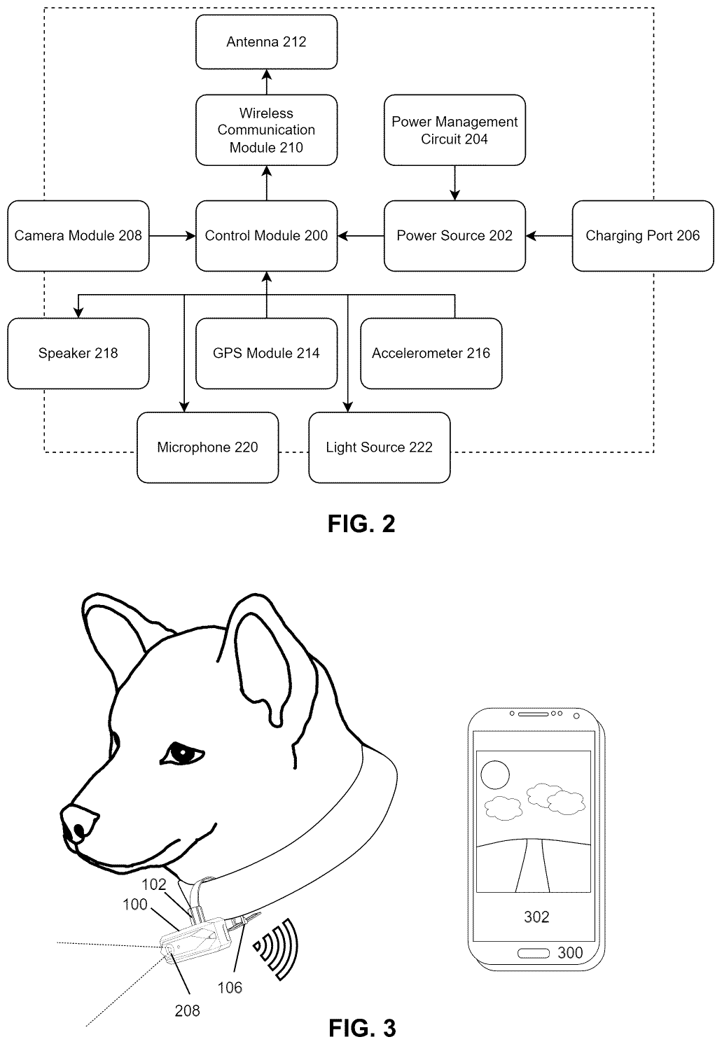

FIG. 3 illustrates the smart pet collar device being worn by a pet, with the adjustable track mechanism configured so that the field of view of the camera module 208 is not obscured by the pet's chin or jaw. The housing 100 is securely attached to the pet collar using the zip-tie ratchet style attachment 106. The adjustable mounting mechanism, including the linear track 102 and rotating wheel 104, allows the housing 100 to be positioned optimally, ensuring that the camera module 208 captures clear and unobstructed video footage from the pet's perspective.

The figure also depicts the smart pet collar device in wireless communication with a user device, shown here as a smartphone 300. The smartphone 300 is running a dedicated mobile application designed to interface with the smart pet collar device. The wireless communication is facilitated by the wireless communication module 210 within the housing 100, supporting 4G LTE and WiFi connectivity. The mobile application on the smartphone 300 provides a user interface 302 that displays a live video stream from the camera module 208, allowing the pet owner to view the pet's surroundings in real time.

The user interface 302 of the mobile application includes functionalities such as displaying the live video feed from the camera module 208 for real-time visual monitoring of the pet's environment. The application includes a map interface showing the current location of the pet, as determined by the GPS module 214, allowing users to view the pet's real-time location as well as historical location data stored in the onboard memory 224. The application provides activity data analyzed from the accelerometer 216, enabling users to monitor their pet's activity levels, rest, and sleep patterns, offering insights into the pet's behavior and health. The user interface 302 includes controls for activating the speaker 218 and microphone 220, allowing users to send voice commands or other audio signals to the pet via the speaker 218 and listen to sounds from the pet's environment through the microphone 220. The application allows users to remotely activate the light source 222 on the housing 100, which can be used to signal the pet or aid in locating the pet in low-light conditions.

Users can set predefined geographic boundaries within the application, and if the pet leaves these boundaries, the control module 200 will send an alert to the smartphone 300, notifying the user that the pet has strayed outside the designated area. The application provides real-time information on the battery level of the power source 202 and includes alerts for low battery levels and notifications when recharging is necessary. The user interface 302 includes options to adjust the position of the camera module 208 via the adjustable mounting mechanism, allowing users to fine-tune the camera angle to ensure the best possible view, accommodating different pet sizes and shapes. The application also allows users to access stored video and location data from the onboard memory 224, enabling review and analysis of past activities and movements of the pet.

### Controller/Processor Components

A control module or processor as described herein can be any suitable type of computer. A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

### Conclusion

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the smart pet collar of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A smart pet collar device, comprising:
a) a housing containing:
i) a camera module disposed at a front surface of the housing;
ii) a GPS module;
iii) a wireless communication module;
b) an adjustable mounting mechanism, the adjustable mounting mechanism comprising:
i) a linear track disposed on the housing;
ii) a rotating wheel coupled to the linear track, enabling the housing to move along the track and to rotate about an axis, thereby allowing the camera module to be positioned at an adjustable offset relative to the collar;
c) an attachment mechanism for securing the housing to a collar, wherein the attachment mechanism allows for repositioning of the housing relative to the collar;
d) a power source disposed within the housing, configured to power the camera module, the GPS module, and the wireless communication module;
e) a control module disposed within the housing, operatively connected to the camera module, the GPS module, and the wireless communication module, wherein the control module is configured to interface with a remote device via the wireless communication module.

2. The smart pet collar device of claim 1, wherein the camera module further comprises an image sensor and a lens, the lens being adjustable to change the field of view, and wherein the camera module is operatively connected to the control module to transmit video data.

3. The smart pet collar device of claim 1, wherein the housing is waterproof, comprising a sealed enclosure to protect the internal electronic components.

4. The smart pet collar device of claim 1, wherein the wireless communication module supports 4G and WiFi connectivity, including an antenna disposed within the housing for signal transmission and reception.

5. The smart pet collar device of claim 1, further comprising a speaker disposed within the housing, operatively connected to the control module, wherein the control module is configured to receive audio data from a remote device and transmit it to the speaker.

6. The smart pet collar device of claim 5, wherein the speaker is configured to emit audio signals and voice commands from a remote device, and the control module includes a digital-to-analog converter for processing audio signals.

7. The smart pet collar device of claim 1, further comprising a microphone disposed within the housing, operatively connected to the control module, wherein the control module is configured to transmit audio data from the microphone to the remote device.

8. The smart pet collar device of claim 1, wherein the control module is configured to interface with a mobile application on a remote device, including a software API for communication between the control module and the mobile application.

9. The smart pet collar device of claim 1, further comprising an accelerometer disposed within the housing, operatively connected to the control module, wherein the accelerometer provides motion data to the control module for activity monitoring.

10. The smart pet collar device of claim 1, wherein the attachment mechanism comprises a zip-tie type attachment, including a locking mechanism for secure attachment to a pet collar.

11. The smart pet collar device of claim 1, further comprising a rechargeable battery as the power source, the battery being disposed within the housing and electrically connected to the control module and other components.

12. The smart pet collar device of claim 11, wherein the housing further comprises a charging port for recharging the battery, the charging port being operatively connected to the battery through a power management circuit.

13. The smart pet collar device of claim 1, wherein the control module is configured to store and transmit location data and video data to the remote device, including onboard memory for temporary data storage.

14. The smart pet collar device of claim 1, further comprising a light source disposed on the housing, operatively connected to the control module, wherein the light source includes an LED and a driver circuit.

15. The smart pet collar device of claim 14, wherein the light source is configured to emit light in response to a signal from the remote device, the signal being processed by the control module to activate the light source.

16. The smart pet collar device of claim 1, wherein the control module is configured to track and record the pet's location history for up to 30 days, including onboard memory for storing location data and a software algorithm for data retrieval and display.

17. The smart pet collar device of claim 1, wherein the control module is configured to analyze the pet's activity data and provide insights into the pet's rest and sleep patterns, including a software algorithm that processes data from the accelerometer to determine sleep and activity states.

18. The smart pet collar device of claim 1, wherein the control module is configured to send alerts to the remote device when the pet leaves a predefined geographic area, including a geofencing algorithm and an alert notification system within the mobile application.

19. The smart pet collar device of claim 1, wherein the control module is configured to generate and display a trace of the pet's route on a map within the mobile application, including GPS data logging and a mapping interface within the software.

20. The smart pet collar device of claim 1, wherein the control module is configured to adjust the frequency of GPS data transmission to conserve battery power when the device is not actively being monitored by the mobile application, including a power management algorithm that dynamically adjusts data transmission intervals.
